(19) United States
(12) Patent Application Publication
(10) Pub. No.: US 2026/0264805 A1
(43) Pub. Date: Sep. 10, 2026

(54) Drive unit for an electric bicycle, having a sealing element

(71) Applicant: Brose Antriebstechnik GmbH & Co. Kommanditgesellschft, Berlin, Berlin (DE)

(72) Inventors: Daniel HUCKSTADT, Berlin (DE); Michael JACOB, Meura (DE); Christoph EHEHALT-BOHM, Kurnach (DE); Stefanie PFRIEM, Gerbrunn (DE); Robert FRIEDLAND, Strausberg (DE)

(21) Appl. No.: 19/160,032

(22) PCT Filed: Feb. 29, 2024
(86) PCT No.: PCT/EP2024/055176

§ 371 Date: Aug. 27, 2025

(30) Foreign Application Priority Data
Mar. 2, 2023 (DE) 10 2023 105 187.3

(51) Int. Cl. B62M 6/55; F16C 19/06; F16C 33/76

(52) U.S. Cl. CPC B62M 6/55; F16C 19/06; F16C 33/763; F16C 2326/20

(57) ABSTRACT

A drive unit for an electric bicycle, having a housing, which holds an electric motor for power-operated generation of a motor torque, an output element for providing a driving torque for driving the electric bicycle, and which is operatively connected to the electric motor via an output shaft for transmitting the motor torque to the output element, wherein the output shaft has an inner section, which is in the interior of the housing and serves for receiving the motor torque from the electric motor, and an outer section, at which the output element for receiving the motor torque from the output shaft is arranged, wherein the housing has a housing opening through which the output shaft projects with the outer section out of the housing, and having a sealing element at the housing opening for sealing the interior of the housing at the output shaft.

### CROSS REFERENCE TO RELATED APPLICATIONS

This application is a National Stage of International Application No. PCT/EP2024/055176 filed on Feb. 29, 2024, which claims priority from German Patent Application No. 10 2023 105 187.3, filed on Mar. 2, 2023. The contents of the above document are incorporated herein by reference in its entirety.

### BACKGROUND OF THE INVENTION

### Field of the Invention The proposed solution relates to a drive unit for an electric bicycle.

### Description of the Related Art

It is known that at least one electric motor is used in combination with a gear device, e.g., having a planetary gear stage, on an electric bicycle, i.e., a so-called e-bike or pedelec, in order to provide motor assistance via an output shaft to be coupled to a wheel of the electric bicycle when riding the electric bicycle.

A motor torque that amplifies and, if necessary, replaces a self torque generated by muscle power is provided by means of the electric motor. The electric motor and the output shaft are coupled to each other via the gear device of the drive unit so that the motor torque can be transmitted to the wheel via the output shaft in combination with the self torque, i.e. as a total torque.

Usually, an output element such as a chain sprocket is provided on the output shaft, via which the total torque is transmitted to the wheel via a power transmission means such as a chain. The output element requires a stop for axial fixation on the output shaft in the direction of the electric motor. The stop is usually implemented by means of a step on the output shaft or a separate retaining ring.

However, for assembly reasons, providing a step on the output shaft requires an increased diameter on all portions of the output shaft following the step. The step can therefore affect the entire radial installation space that must be provided for the drive unit on the electric bicycle. However, in particular, an excessive radial installation space of a drive unit that is to be installed on an electric bicycle in place of a pedal crank shaft should be avoided, because it is desirable in electric bicycles to be able to position the pivot point of a spring-mounted rear wheel swing arm as close as possible to the rotational axis of the output shaft.

The provision of a separate retaining ring can increase the axial installation space required for the drive unit (Q factor). Typically, the drive unit is arranged between two pedal cranks, via which the self torque generated by the muscle power of the legs of a rider of the electric bicycle is introduced into the drive unit. The required axial installation space can therefore have a direct impact on the body posture of the rider of the electric bicycle. Depending on the rider's height, this may require an uncomfortable body posture from the rider.

A large drive unit may consequently cause undesirable design restrictions.

The task is therefore to create a drive unit for an electric bicycle that requires little radial installation space.

### SUMMARY OF THE INVENTION

Against this background, the drive unit of claim 1 is proposed.

A proposed drive unit for an electric bicycle comprises at least the following:
a housing, in the interior of which an electric motor is arranged for the externally powered generation of motor torque,
an output element for providing a drive torque for driving the electric bicycle, which is arranged outside the housing and is operatively connected to the electric motor via an output shaft for transmitting the motor torque to the output element, wherein the output shaft has an inner portion which is arranged in the interior of the housing and serves to receive the motor torque from the electric motor, and an outer portion which is arranged outside the housing and on which the output element is arranged to receive the motor torque from the output shaft, wherein the housing has a housing opening through which the output shaft protrudes from the housing with the outer portion,
a sealing element on the housing opening for sealing the interior of the housing at the output shaft, and
a counter element arranged on the output shaft and having a support surface located radially outward of a rotational axis of the output shaft, on which the sealing element is radially supported on the counter element, wherein the output element abuts against the counter element.

By abutment of the output element against the counter element an installation space of the drive unit can be reduced in the axial direction and in the radial direction compared to drive units in which the output element abuts against a step on the output shaft or against a retaining ring as described above. This makes it possible to provide a drive unit that has a low Q factor and can therefore be used for electric bicycles that can accommodate a wide range of rider body heights.

In particular, no step is required on the output shaft, which could cause an increase in the radial installation space of the drive unit due to mounting restrictions. The increase can occur because the additional radial installation space required for the step cascades along the output shaft to an outer contour of the housing.

The use of a counter element for the sealing element can make it possible to form the output shaft from a light metal, because only the material of the counter element needs to provide the surface hardness required for the sealing element to run. The counter element can therefor be made of a harder material than light metal, for example steel. Such a counter element can be formed, for example, by a running ring. The sealing element can be a shaft sealing ring.

The output element may comprise, for example, a chain sprocket or a belt pulley or a carrier for a chain sprocket or a belt pulley. A power transmission means such as a chain or a belt may be guided over the output element to transmit the torque from the output shaft to the wheel of the electric bicycle. The output shaft may, for example, be a hollow shaft. In one embodiment, the output shaft has a plurality of form-fitting elements that extend axially along a connecting portion on the output shaft and via which the output shaft is connected to the output element in a rotatably fixed manner, wherein the counter element overlaps the connecting portion axially. The plurality of form-locking elements can form a toothing on the output shaft, which is arranged in a sheath-like manner on the output shaft. The teeth of the toothing can be elongated along the rotational axis of the output shaft. The output element can be arranged on a subportion of the connecting portion for a rotationally fixed connection.

The fact that the (entire) connecting portion is longer than the subportion required by the output element may be due, on the one hand, to the fact that the output element is plugged onto the output shaft and guided along the output shaft far enough so that a fastening element is located on a portion of the output shaft that is passed by the output element during mounting. On the other hand, it may be economically advantageous to manufacture the plurality of form-fitting elements in such a way that the connecting portion has a portion that is not usable for connection with the output element.

The overlap of the counter element with the connecting portion allows the connecting portion to be used more efficiently, thus saving axial installation space. Therein, the counter element may overlap the connecting portion completely or only partially.

In a further embodiment, the plurality of form-locking elements is formed by grooves extending axially on an outer surface of the output shaft, the depth of which decreases in the direction of the inner portion of the output shaft at a run-out portion of the connecting portion, wherein the counter element overlaps axially with the run-out portion. In principle, the grooves by which the plurality of form-fitting elements is formed can be of any shape. The axial extension of the grooves along the outer surface of the output shaft can be of the type of a splined shaft and can serve to transmit the torque particularly efficiently. In this case, wedges for engaging in the output element can be formed between the grooves. Other form-fitting connections between the output shaft and the output element are also conceivable and possible.

The decrease in the depth of the grooves in the direction of the inner portion of the output shaft may be due to the fact that the grooves were produced using the economically advantageous manufacturing method of hobbing. Such a manufacturing method can lead to a run-out of toothing during the manufacture of toothings. Due to the fact that the counter element overlaps axially with the run-out portion, the axial installation space required by the run-out portion can be used to support the sealing element and thus does not remain unused during operation in accordance with this embodiment.

In one embodiment, the counter element has a sealing portion, via which it is arranged on a portion of the output shaft adjacent to the connecting portion, and a retaining portion, via which it is arranged on the connecting portion. In principle, the counter element can be arranged along its entire axial length on the connecting portion. However, it may be advantageous for the counter element to be arranged with the sealing portion on the portion of the output shaft adjacent to the connecting portion in order to achieve a better seal of the run-out portion against the interior of the housing. The retaining portion can serve to hold the counter element on the output shaft, for example, via a threaded connection or by press-fitting it onto sealing lips arranged on the inside of the counter element.

In one embodiment, the counter element is non-metallic at least in portions on a side facing the output shaft and/or metallic at least in portions on a side facing the sealing element. The side of the counter element facing the output shaft can form an inner side of the (preferably ring-shaped) counter element. In particular, the counter element can consist of rubber in portions, preferably on the inner side. At least the counter element can be non-metallic in portions at the sealing portion in order to seal the run-out portion via the sealing portion. A non-metallic configuration of the counter element on the side facing the output shaft may, for example, comprise a layer element located on the inside with which a metallic body of the counter element is coated. The layer element may have one or more sealing lips which contribute to sealing the run-out portion over the sealing portion. The counter element can be configured particularly simply and inexpensively as a stamped part. If the layer element is provided for effective sealing, no additional thread needs to be provided on the counter element, which simplifies manufacture.

The metallic portion of the side facing the sealing element can comprise the support surface for the sealing element. The sealing element can thus be provided with a support surface over which it can easily run when the output shaft and thus the counter element rotates. In addition, the metal of the portion can be configured in such a way that the running properties of the sealing element and its resistance to wear are optimal.

By configuring the counter element from two different material components (e.g., metal and rubber), the counter element can provide, in addition to the abutment for the output element, a suitable support surface for the sealing element on the one hand and a sealing function on the output shaft on the other hand. An installation space of the drive unit can thus be configured more compactly, as it can be dispensed with additional elements such as a retaining ring or a step on the output shaft.

In one embodiment, the output element is axially fixed between the counter element and a fastening element on the output shaft. The counter element provides a housing-side stop for the output element, while the fastening element provides a housing-remote stop for the output element. The fastening element may comprise, for example, a nut. A thread may be provided on the output shaft for arranging the fastening element on the output shaft.

In one embodiment, the output shaft has a radial step on which the counter element is supported at least indirectly in the axial direction. The radial step can form a stop that indirectly absorbs an axial force resulting from the fixing of the output element on the output shaft. Indirectly can be understood here to mean that further elements may be arranged between the counter element and the radial step, via which the support is provided. In principle, direct support of the counter element on the radial step is also conceivable and possible.

In one embodiment, the counter element is supported on the radial step by at least one of a first ball bearing assembly, via which the output shaft is rotatably supported on the housing, a ring element, and/or a second ball bearing assembly, via which a drive wheel for receiving the motor torque from the electric motor is supported on the output shaft. The above list of elements is a selection of possible elements that can be arranged between the counter element and the radial step. The fastening element can thus be used to fix the counter element, the output element, and one or more possible further elements to the radial step. The ring element may comprise a spacer ring, by means of which the two ball bearing assemblies are spaced apart from each other.

In one embodiment, the output shaft is rotatably supported on the housing via a first ball bearing assembly (e.g., the first ball bearing assembly just described), wherein the first ball bearing assembly has a first inner ring for receiving a plurality of first bearing elements, which has a recess on the side of the counter element on the side facing the output shaft in a sectional plane along the rotational axis of the output shaft, in which a sealing compound is arranged. The recess can be formed by a rounded edge of an axially revolving rim of the inner ring. The sealing compound can comprise, for example, rubber and/or grease, in particular in the form of a grease bead. In principle, the sealing compound can be provided as an O-ring.

A layer element arranged on the side of the counter element facing the output shaft may have a chamfer on the side of the first ball bearing assembly or at least be retracted behind an abutment surface of the counter element on the first ball bearing assembly. This may simplify the mounting of the counter element on the output shaft. Also with such a layer element, sufficient sealing may already be achieved under certain circumstances. The sealing can be further improved if the sealing compound is additionally provided between the counter element and the first ball bearing assembly.

In one embodiment, the sealing compound is formed integrally with the layer element arranged on the side of the counter element facing the output shaft. In particular, the sealing compound can be part of a non-metallic portion of the counter element which is arranged on a side of the counter element facing the output shaft. When mounting such a counter element, the sealing compound can be pressed into the recess so that it nestles into it. For example, the sealing compound can form a bead or wedge element on the counter element or its layer element, which may protrude from the counter element toward the first ball bearing assembly on the side facing the output shaft. With such a sealing compound, good sealing can be achieved even with a larger tolerance range of the components of the drive unit.

The proposed solution also relates to an electric bicycle with an embodiment of a proposed drive unit.

### BRIEF DESCRIPTION OF THE DRAWINGS

The accompanying figures illustrate exemplarily possible embodiments of the proposed solution.

FIG. 1 shows a schematic sectional view of a drive unit;

FIG. 2A shows a sectional view of a drive unit with a pedal crank;

FIG. 2B shows an enlarged excerpt of FIG. 2A;

FIG. 3A shows a first perspective view of a counter element; and

FIG. 3B shows a second perspective view of a counter element.

### DETAILED DESCRIPTION OF THE DRAWINGS

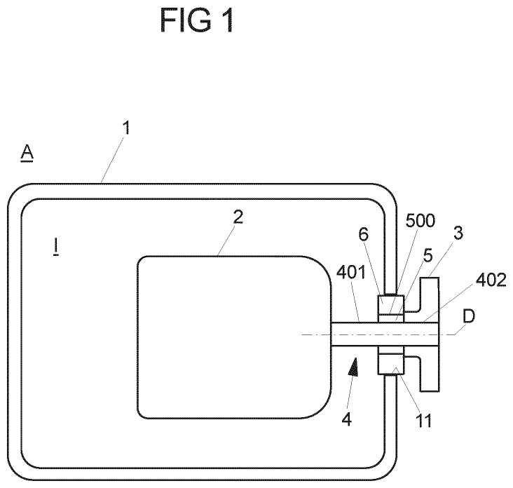

FIG. 1 shows a sectional view through a drive unit for an electric bicycle. The drive unit has a housing 1, in the interior of which an electric motor 2 is arranged. The housing 1 protects the electric motor 2, for example, from dust and moisture that may occur in an outer area A, which is separated from the interior I by the housing 1, during normal operation of the drive unit on an electric bicycle. The electric motor 2 is used for the externally powered generation of a motor torque.

The motor torque is transmitted to an output element 3 in order to provide a drive torque for driving the electric bicycle. The drive torque can be transmitted to a wheel of the electric bicycle, for example by means of a chain (not shown) or a belt. The output element 3 is arranged outside the housing 1 and is operatively connected to the electric motor 2 via an output shaft 4. The output shaft 4 serves to transmit the motor torque to the output element 3. Further gear elements, which are not shown, may be arranged between the electric motor 2 and the output shaft 4.

The output shaft 4 has an inner portion 401 which is arranged in the interior I of the housing 1 and serves to receive the motor torque from the electric motor 2. In addition, the output shaft 4 has an outer portion 402 which is arranged outside the housing 1 and on which the output element 3 is arranged to receive the motor torque from the output shaft 4.

Since the output element 3 is arranged outside the housing 1, the housing 1 has a housing opening 11 through which the output shaft 4 protrudes with the outer portion 402 from the housing 1 to enable arrangement of the output element 3 on the output shaft 4.

Due to the housing opening 11, it is necessary to provide a sealing element 6 which serves to seal the interior of the housing 1 at the output shaft 4. The sealing element 6 surrounds the output shaft 4 in an annular manner and prevents, for example, dust and moisture from entering from the outer area A through the housing opening 11 into the interior I.

A counter element 5 is arranged on the output shaft 4 to support the sealing element 6. The counter element 5 has a support surface 500 located radially outside a rotational axis of the output shaft 4, on which the sealing element 6 is radially supported on the counter element 5. The sealing element 6 therefore has no direct contact with the output shaft 4.

The output element 3 abuts against the counter element 5. An axial force acting from the output element 3 in the direction of the electric motor 2 can thus be absorbed by the counter element 5. In addition, the outer portion 402 of the output shaft 4 is separated from the inner portion 401 of the output shaft 4 by the counter element 5.

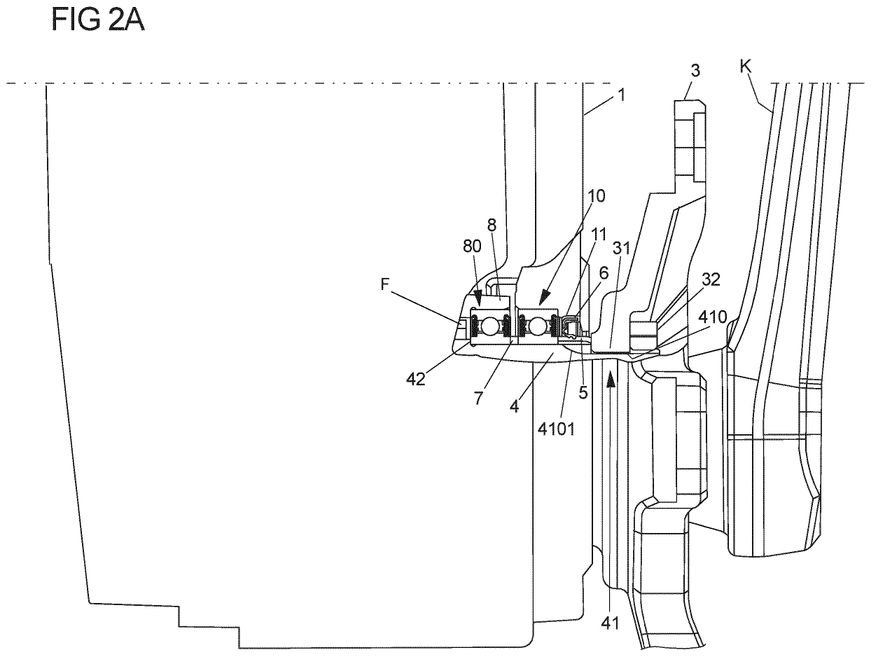

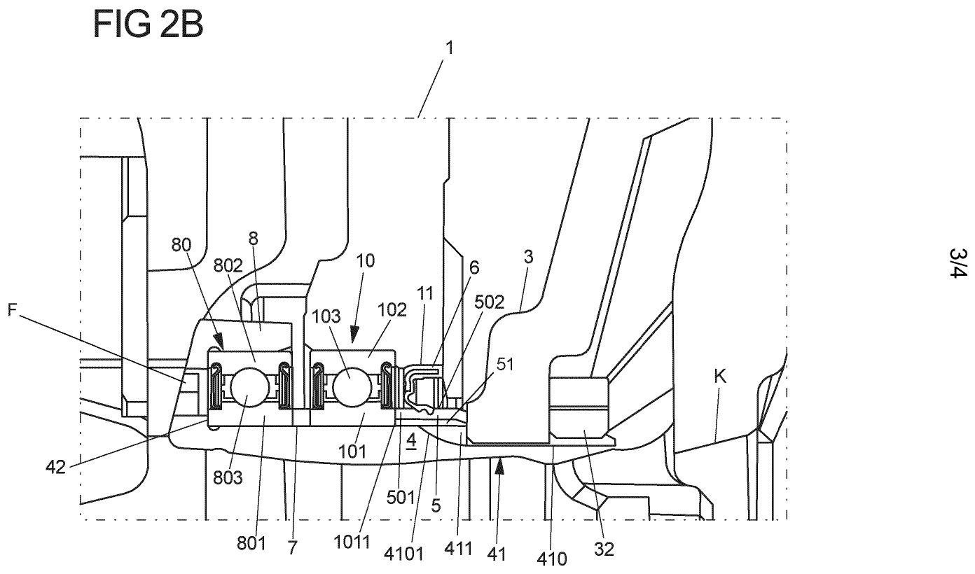

The interior I is sealed off from the outer space at the counter element 5, on the one hand by the sealing element 6 between the counter element 5 and the housing 1 and, on the other hand, between the counter element 5 and the output shaft 4. The latter sealing can be provided by the counter element 5 itself. FIG. 2A shows a sectional view of a configuration of the drive unit of FIG. 1. To illustrate the normal use of the drive unit, a pedal crank K is also shown, which is arranged thereon and via which, in an electric bicycle, a torque generated by the muscle power of the legs of a rider of the electric bicycle is introduced into the drive unit.

The output shaft 4 of the drive unit is rotatably supported on the housing 1 via a first ball bearing assembly 10. A second ball bearing assembly 80 is provided for rotatably supporting a drive wheel 8 for receiving the motor torque of the electric motor 2 of the drive unit on the output shaft 4. The transmission of the motor torque is particularly made via a freewheel assembly F. A ring element 7 is arranged between the ball bearing assemblies 10, 80, which keeps the two ball bearing assemblies 10, 80 spaced apart from each other. A fastening element 32 is arranged on the output shaft 4 at the very outside in the axial direction. The output element 3 abuts against this in the axial direction on the housing side. This in turn abuts against the counter element 5 in the axial direction on the housing side. The counter element 5 abuts against the first ball bearing assembly 10. This is followed by the ring element 7 and the second ball bearing assembly 80. The second ball bearing assembly 80 abuts against a radial step 42 of the output shaft 4. An axial force from the fastening element 32 or the output element 3 is thus indirectly introduced into the radial step 42.

The output element 3 is held on a connecting portion 41 of the output shaft 4 on the output shaft 4. The connecting portion 41 is formed by a plurality of grooves 410 which extend axially on the output shaft 4 in the manner of a splined shaft so that wedges 411 are formed between them. The output element 3 engages in the grooves 410 with engagement elements 31, so that the output element 3 is held rotationally fixed on the output shaft 4. The grooves 410 are machined into the output shaft 4 starting from an outer end of the output shaft 4, so that an outer contour of the output shaft 4 is jagged on a radial plane at the outer end (due to the wedges 411 protruding above the grooves 410). The jags of the outer contour are preferably formed rectangularly. A cross-section through the wedges 411 can therefore be rectangular. The grooves 410, on the other hand, can be U-shaped in cross-section.

On the housing side, i.e. towards an inner portion 401 of the output shaft 4, which is arranged inside the housing 1, the depth of the grooves 410 decreases at a run-out portion 4101 of the connecting portion 41. The decrease is due to the manufacturing process of hobbing the grooves 410. The counter element 5 is arranged so that it overlaps axially with the run-out portion 4101.

In the enlarged excerpt of the sectional view of FIG. 2A shown in FIG. 2B, it can be seen that the counter element 5 has a retaining portion 502 located outside and a sealing portion 501 located inside, wherein the retaining portion 502 overlaps the run-out portion 4101 and the sealing portion 501 is arranged axially outside the connecting portion 41. The sealing portion 501 is arranged axially inside the connecting portion 41 so that it seals it off from the interior I of the housing 1. This prevents dust or water that can enter the grooves 410 of the output shaft 4 from the outside from entering the interior I and, in particular, the first ball bearing assembly 10 via the run-out portion 4101.

For a good sealing, it is advantageous that the counter element 5 is non-metallic on the side facing the output shaft 4 so that it can nestle better to the output shaft 4. For this purpose, the counter element 5 has a layer element 51 which extends along the entire inner side of a body 50 of the counter element 5, which does not exclude the possibility that it may be chamfered or otherwise being retracted or protruding on one of the axial sides of the counter element 5. At the sealing portion 501, the sectional non-metallic configuration of the counter element 5, in particular in the form of a rubber layer, has the advantage that better overpressing is provided at a sealing location between the counter element 5 and the output shaft 4. In addition, the danger of damage to the output shaft 4 during mounting of the counter element 5, in particular at the outer portion 410, is lower with a sectionally non-metallic configuration of the counter element 5.

The first and second ball bearing assemblies 10, 80 each comprise a first and second inner ring 101, 801 and a first and second outer ring 102, 802, between which a plurality of first and second bearing elements 103, 803 are arranged. The first and second ball bearing assemblies 10, 80 are each mounted on the output shaft 4 via their inner rings 101, 801. The counter element 5 abuts against the first inner ring 101 and the ring element 7 lies between the first and second inner rings 101, 801. The second ball bearing assembly 80 is supported on the radial step 42 of the output shaft 4 via the second inner ring 801. The arrangement of the elements provides a continuous line of force from the output element 3 via the counter element 5 to the radial step 42. The first and second ball bearing assemblies 10, 80 lie with their inner rings 101, 801 in this line of force.

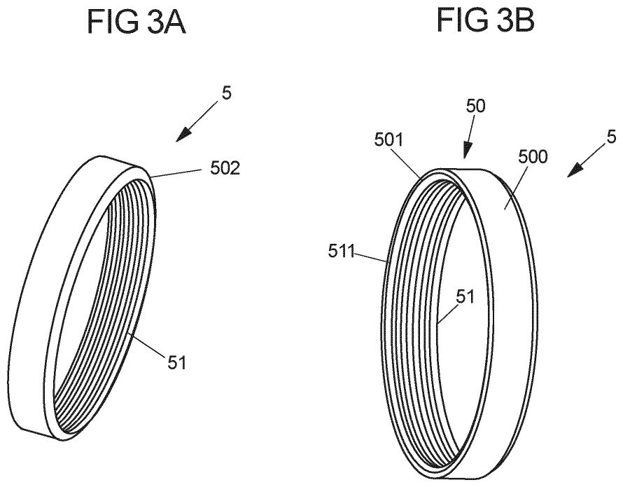

FIG. 3A and FIG. 3B show perspective views of the counter element 5. The counter element 5 has a body 50 made of metal, for example, steel. The body 50 provides the support surface 500 for the sealing element 6. The support surface 500 provides a cylindrical barrel surface for supporting the sealing element 6. During operation, the sealing element 6 runs on the support surface 500, or the output shaft 4 rotates together with the counter element 5 under the sealing element 6 on the support surface 500.

The counter element 5 has a layer element 51 located radially inward, which is non-metallic. The layer element 51 consists, for example, of rubber. On a side of the counter element 5 which is arranged on the side of the housing on the drive unit during normal use, the layer element 51 forms a chamfer 511 which is provided to receive a sealing compound (e.g. an O-ring). Alternatively, the layer element 51 can protrude axially beyond the body 50, e.g. in the form of a wedge or a bead, wherein the protruding, in the state of being mounted as intended, is pressed into a recess 1011 on an inner ring 101 of the first ball bearing assembly 10 in order to achieve a better sealing. On the opposite side, which is arranged on the outside on the drive unit (on the retaining portion 502) during intended use, the body 50 of the counter element 5 has a revolving rounded edge lying on the support surface 500. The rounded edge serves to gradually expand the sealing element 6 on the counter element 5 during mounting of the sealing element 6. This facilitates mounting because, for example, no additional mounting sleeve is required for the sealing element 6 and because the sealing element 6 is protected against unintentional shearing on the counter element 5.

The invention claimed is:

1. A drive unit for an electric bicycle, comprising:
a housing, in the interior of which an electric motor is arranged for the externally powered generation of motor torque,
an output element for providing a drive torque for driving the electric bicycle, which is arranged outside the housing and is operatively connected to the electric motor via an output shaft for transmitting the motor torque to the output element,
wherein the output shaft has an inner portion which is arranged in the interior of the housing and serves to receive the motor torque from the electric motor, and an outer portion which is arranged outside the housing and on which the output element is arranged to receive the motor torque from the output shaft,
wherein the housing has a housing opening through which the output shaft protrudes from the housing with the outer portion, a sealing element on the housing opening for sealing the interior of the housing at the output shaft, wherein a counter element arranged on the output shaft and having a support surface located radially outward of a rotational axis of the output shaft, on which the sealing element is radially supported on the counter element, and
wherein the output element abuts against the counter element.

2. The drive unit according to claim 1, wherein the output shaft has a plurality of form-fitting elements that extend axially along a connecting portion on the output shaft and via which the output shaft is connected to the output element in a rotatably fixed manner, and
wherein the counter element overlaps the connecting portion axially.

3. The drive unit according to claim 2,
wherein the plurality of form-locking elements is formed by grooves extending axially on an outer surface of the output shaft, the depth of which decreases in the direction of the inner portion of the output shaft at a run-out portion of the connecting portion, and
wherein the counter element overlaps axially with the run-out portion.

4. The drive unit according to claim 2 wherein the counter element has a sealing portion, via which it is arranged on a portion of the output shaft adjacent to the connecting portion, and a retaining portion, via which it is arranged on the connecting portion.

5. The drive unit according to claim 1 wherein the counter element is non-metallic at least in portions on a side facing the output shaft, in particular consists of rubber at least in portions, and/or metallic at least in portions on a side facing the sealing element.

6. The drive unit according to claim 1 wherein the output element is axially fixed between the counter element and a fastening element on the output shaft.

7. The drive unit according to claim 1 wherein the output shaft has a radial step on which the counter element is supported at least indirectly in the axial direction.

8. The drive unit according to claim 7, wherein the counter element is supported on the radial step by at least one of a first ball bearing assembly, via which the output shaft is rotatably supported on the housing, a ring element, and/or a second ball bearing assembly, via which a drive wheel for receiving the motor torque from the electric motor is mounted on the output shaft.

9. The drive unit according to claim 1 wherein the output shaft is rotatably supported on the housing via a first ball bearing assembly, and
wherein the first ball bearing assembly has a first inner ring for receiving a plurality of first bearing elements, which has a recess on the side of the counter element on the side facing the output shaft in a sectional plane along the rotational axis of the output shaft, in which a sealing compound is arranged.

10. The drive unit according to claim 9, wherein the sealing compound is formed integrally with the layer element arranged on the side of the counter element facing the output shaft.

11. An electric bicycle comprising:
a drive unit for an electric bicycle, comprising:
a housing, in the interior of which an electric motor is arranged for the externally powered generation of motor torque,
an output element for providing a drive torque for driving the electric bicycle, which is arranged outside the housing and is operatively connected to the electric motor via an output shaft for transmitting the motor torque to the output element,
wherein the output shaft has an inner portion which is arranged in the interior of the housing and serves to receive the motor torque from the electric motor, and an outer portion which is arranged outside the housing and on which the output element is arranged to receive the motor torque from the output shaft,
wherein the housing has a housing opening through which the output shaft protrudes from the housing with the outer portion, a sealing element on the housing opening for sealing the interior of the housing at the output shaft, wherein a counter element arranged on the output shaft and having a support surface located radially outward of a rotational axis of the output shaft, on which the sealing element is radially supported on the counter element,
wherein the output element abuts against the counter element.
